(19) United States
(12) Patent Application Publication
(10) Pub. No.: US 2020/0384926 A1
(43) Pub. Date: Dec. 10, 2020

(54) LIGHTWEIGHT NOISE AND VIBRATION DAMPENING GLOVE BOX

(71) Applicant: Motus Integrated Technologies, Holland, MI (US)

(72) Inventors: Michael J. Camella, Huron, OH (US); John J. Todd, Farmington Hills, MI (US); Tyler J. Rule, Highland, MI (US)

(21) Appl. No.: 16/898,414

(22) Filed: Jun. 10, 2020

Related U.S. Application Data
(60) Provisional application No. 62/859,692, filed on Jun. 10, 2019.

(51) Int. Cl. B60R 7/06; B29C 35/02; B29C 35/16

(52) U.S. Cl. CPC B60R 7/06; B29L 2031/3005; B29C 35/16; B29C 35/02

(57) ABSTRACT

A weight and noise reducing glovebox assembly made of an inner glovebox bin composed of a pair of thermopolymer fiber layers that work in concert to absorb noise and isolate noise and vibration providing a glovebox with improved NVH characteristics. The glovebox bin is formed of a three dimensionally chill formed structural layer composed of PET fiber to which is mated, preferably by needle tacking, an inner carpet layer also composed of PET fiber providing two stage noise, sound and vibration reduction. In a preferred embodiment, the inner PET fiber carpet layer is mated, preferably by needle tacking, to an outer structural moldable PET fiber substrate layer forming a two-stage sound, noise and vibration absorbing and isolating thermoformable blank that is chilled formed into a sound absorbing glovebox bin of one piece flip open construction that is lighter in weight and which has reduced sound and noise generation and transmission compared to conventional hard plastic gloveboxes.

### CROSS REFERENCE TO RELATED APPLICATIONS

This application claims priority from and the benefit of U.S. Provisional Application Ser. No. 62/859,692, entitled “LIGHTWEIGHT NOISE AND VIBRATION DAMPENING GLOVE BOX,” filed Jun. 10, 2019, which is hereby incorporated by reference in its entirety for all purposes.

The present invention is directed to an improved vehicle glovebox and more particularly to a vehicle glovebox of molded fibrous composite construction that is lighter in weight and which has improved noise and vibration characteristics.

Vehicles of all different kinds, including wheeled land vehicles, are equipped with a glove box, also known as a glove compartment, in which articles, such as manuals, maps, sunglasses, tools, and the like can be stored during vehicle use and operation. A glove box typically is composed of a glovebox compartment, a door or lid, a bracket that defines a hinge that enables the door, e.g., lid, to be opened to access articles in the compartment and closed to house or protect the articles within the compartment, a light to illuminate the contents in the compartment, and a lock to secure the contents within the compartment when the door is closed.

### BRIEF DESCRIPTION

The present invention is directed to a vehicle glove box that has a glovebox compartment of molded structural fiber construction that is lightweight, resilient, sound absorbing and which also advantageously has a decorative surface. A preferred molded structural fibrous glovebox compartment may be and preferably is three-dimensionally formed in a single step from a formable or moldable material composed of fiber as opposed to plastic (e.g., via plastic molding), such as polyethylene terephthalate (PET) fibers. One such preferred molded structural fibrous glovebox compartment preferably is formed of one piece and unitary construction that is formed in a single step of a formable or moldable material that is a moldable substrate blank that is thermally formed, such as by thermoforming, to produce a one-piece glovebox compartment of the present invention that only needs to be attached to a glove box cover or lid to form a complete glovebox assembly ready for assembly to a vehicle.

A glovebox assembly of the present invention has a glove box compartment formed of a moldable substrate that has been three dimensionally formed or molded, such as by convective or conductive thermal forming or molding, into the desired three-dimensional glovebox compartment shape that can be assembled into a glovebox opening in a vehicle dashboard or dash panel, either prior to or after attachment of a glovebox cover or lid thereto. A preferred three-dimensionally moldable substrate that forms the glovebox compartment is formed of a moldable substrate composed of a thermoplastic polymer fiber, such as a polyester fiber, e.g., polyethylene terephthalate (PET) fiber, arranged to produce a woven or nonwoven three-dimensionally formable blank that is heat formed via convective heating, e.g., using a heat gun or the like, or conductive heating, e.g., using a heated platen, into the desired glovebox shape.

A glovebox assembly of the present invention is made of a noise reducing glovebox inner bin of flip open construction composed of synthetic, e.g., plastic, fiber material, preferably PET fiber material, which is mated to a glove box door assembly that absorbs noise and preferably also dampens vibration. A preferred glovebox assembly includes a glovebox bin made of a multilayer thermoplastic fiber material, preferably PET fiber material, having one layer formed of a structurally supporting moldable fibrous substrate that is mated to or with a fibrous carpet layer where the fibrous carpet layer preferably is an inner soft-touch carpet face that prevents noise generation by gently cushioning articles within the glovebox bin. In a preferred embodiment, the moldable substrate is composed of an engineered blend of PET fibers of 6-15 denier matrix fiber bound together with a high temperature crystalline or amorphous binder to provide the structural support to the inner glovebox bin when three dimensionally chill formed and a soft-touch inner carpet face composed of PET fiber is needle tacked to the moldable substrate to form a thermally moldable blank that is chill formed into the three dimensional glovebox bin shape. Such a two layer PET fiber glovebox bin advantageously has (1) a soft-touch noise absorbing cushioning inner carpet layer that prevents rattling and noise generation by cushioning and isolating objects in the glovebox bin preventing them from creating or generating noise, and (2) a structurally supporting noise and vibration isolating moldable substrate layer that not only helps absorb noise but which also provides noise and vibration isolation thereby preventing noise and vibration transmission from and through the glovebox bin during vehicle operation.

A glovebox constructed in accordance with the present invention advantageously provides improvements in the areas of weight, more specifically reduced weight, acoustics, namely reduced noise generation and noise suppression, vibration, namely is of vibration isolating construction, durability, namely is resilient and more durable in construction, aesthetics, namely has a desirable or pleasant appearance, and may be and preferably is three-dimensionally formed in a single thermal forming step. Such a glovebox made in accordance with the present invention may be and preferably is formed as a single piece three dimensionally formed to produce sidewalls and an endwall defining a recessed article-holding glovebox compartment. Such a glovebox of the present invention is a glovebox of durable, lightweight, flexible, tough, impact resistant, energy absorbing, sound deadening, and vibration isolating construction.

Various other features, advantages, and objects of the present invention will be made apparent from the following detailed description and any appended drawings.

### BRIEF DESCRIPTION OF THE DRAWINGS

One or more preferred exemplary embodiments of the invention are illustrated in the accompanying drawings in which like reference numerals represent like parts throughout and in which:

FIG. 1 is a perspective view of an embodiment of a glovebox;

FIG.2 is a top plan view of an embodiment of the glovebox of FIG. 1;

FIG.3 is a bottom plan view of an embodiment of the glovebox of FIG. 1;

FIG.4 is a right-side elevation view of an embodiment of the glovebox of FIG. 1;

FIG.5 is left-side elevation view of an embodiment of the glovebox of FIG. 1; and

FIG. 6 is a flowchart of an embodiment of a process suitable for manufacturing the glovebox of FIG. 1.

### DETAILED DESCRIPTION

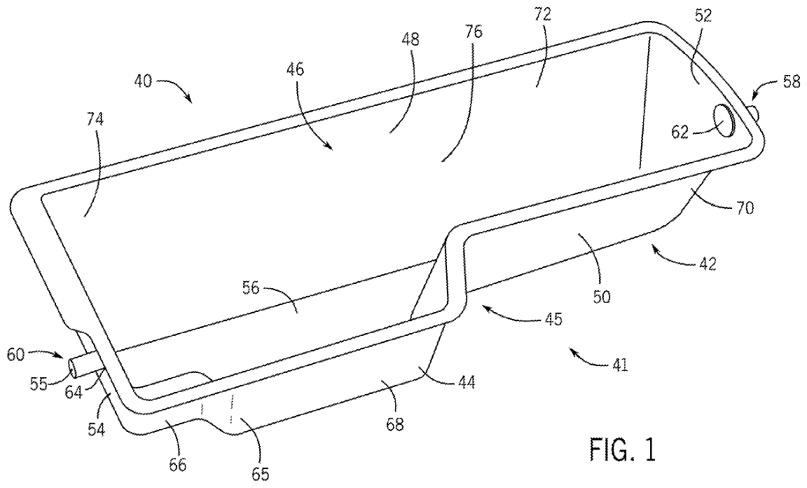

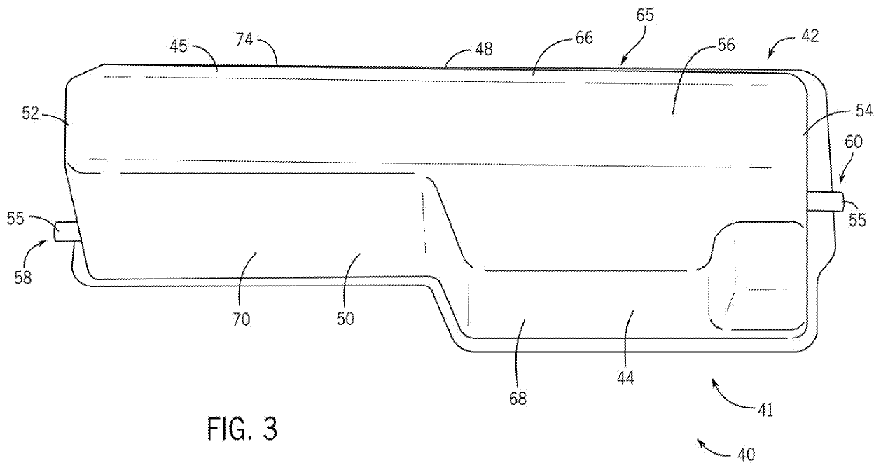

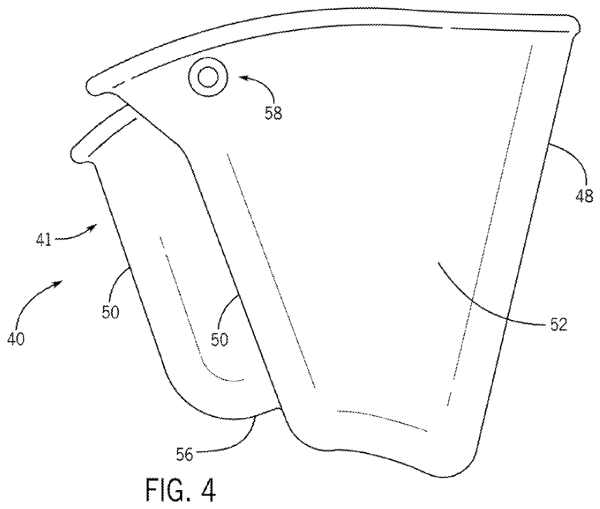

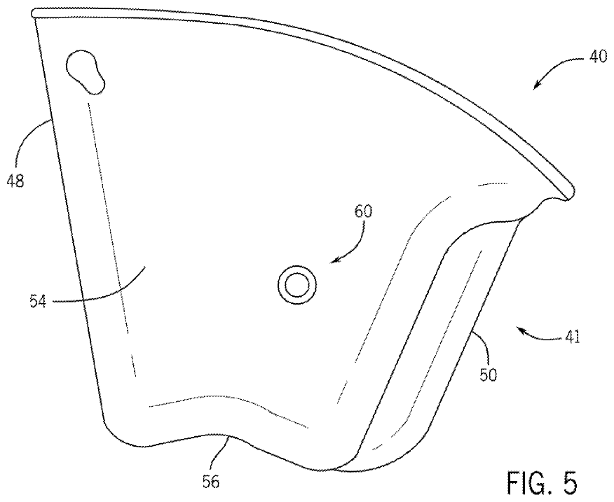

With reference to FIGS. 1-5, the present embodiments are directed to an improved sound absorbing and vibration isolating glovebox 40 constructed from a single moldable blank 42 that is thermally molded to form a three-dimensionally shaped molded glovebox substrate 44 to produce the glovebox 40 with a recessed article-holding compartment 46 that possesses improved noise and vibration characteristics and which also is lighter in weight than conventional gloveboxes. The glovebox blank 42 is a panel or sheet composed of a thermally formable material, preferably a thermoplastic material, which may be and preferably is dispensed from a roll of the thermally formable blank material during manufacturing of the glovebox 40 and thermally formed, such as by application of convective, radiant, and/or conductive heat to the blank 42. Such heat is applied sufficient to plastically deform the blank 42 enabling the heat-softened blank 42 to be molded by being three-dimensionally formed about and/or around a glovebox mold (not shown), such as a platen or platen-containing mold, which imparts a desired three-dimensional glovebox shape to the molded substrate 44. In one preferred method of molding a glovebox 40 in accordance with the invention, the moldable blank 42 is thermoformed through substantially simultaneous application of heat and vacuum to pull the moldable blank 42 against a mold (not shown) having a desired three-dimensionally contoured glovebox shape that thermoforms the blank 42 into a molded structurally self-supporting glovebox substrate 44 having a desired glovebox shape substantially the same as or like that depicted in FIGS. 1-5.

Application of such sufficient heat plastically deforms the blank 42 around the glovebox mold (not shown) three dimensionally shaping the blank 42 to produce a molded structurally self-supporting molded glovebox substrate 44 having spaced apart front and rear walls 48, 50, spaced apart sidewalls 52, 54, and an endwall 56 extending therebetween collectively defining the recessed article-holding compartment 46 of the glovebox 40. When cooled after molding, the shape memory of the three-dimensional configuration or shape of the molded glovebox substrate 44 becomes permanently set or fixed thereby retaining the three-dimensional shape of the molded substrate 44 with the three-dimensionally shaped molded substrate 44 being structurally supporting and/or defining the structural shape of the glovebox 40. If desired, the molded glovebox substrate 44 can be allowed to cool or a separate cooling step can be performed after molding to cool the molded substrate 44 to fix its three dimensionally contoured glovebox shape.

In another preferred method of forming discussed in more detail below, the moldable blank 42 is three dimensionally formed into the glovebox 40 using chill molding. Where chill molding is employed, the moldable blank 42 is three dimensionally formed about a chill mold or chill molding tools configured to three dimensionally shape or mold the blank 42 into glovebox 40.

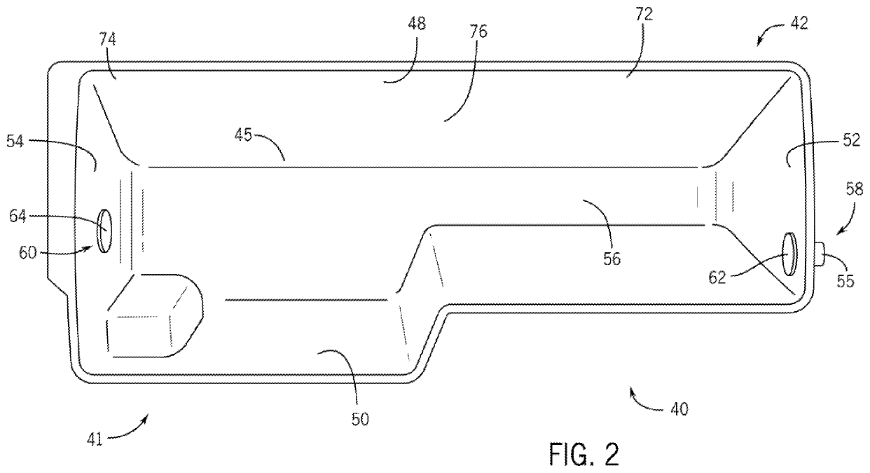

One such implementation of a method of making a glovebox 40 in accordance with the present invention advantageously produces a glovebox 40 of flip-open type construction that has a thermally formed three-dimensionally shaped structurally supporting glovebox article-holding compartment forming body 45 of one-piece and unitary construction. Structurally supporting three dimensionally shaped glovebox body 45 is formed of the three dimensionally shaped glovebox substrate 44 after molding is complete and the substrate 44 has cooled sufficiently to fix its shape memory in the form of a three-dimensionally contoured glovebox 40 with a three-dimensionally shaped recessed glovebox article-holding compartment 46 as best depicted in FIGS. 1 and 2.

In a preferred glovebox substrate forming method and glovebox forming mold (not shown) of the present invention, the mold is configured with a pair of spaced apart glovebox sidewall forming surfaces, which can be generally parallel to one another, and which each preferably also have a generally cylindrical glovebox pivot pin forming recess into which at least a portion of the blank 42 is drawn during molding of the molded glovebox substrate 44 respectively forming pivot pins 58, 60 extending oppositely outwardly from corresponding glovebox sidewalls 52, 54 when molding is finished. In another preferred glovebox and glove box forming and/or manufacturing method, a generally circular bore or opening 62, 64 is formed in each sidewall 52, 54 through which a respective generally cylindrical pivot pin 58, 60 is telescopically received or inserted having one pivot end fixed or otherwise anchored to corresponding sidewall 52, 54. The pivot pins 58, 60 preferably are coaxially aligned with one another about a central longitudinal axis of an elongate generally cylindrical pivot pin body 55 forming the corresponding pivot pins 58, 60. Pivot pins 58, 60 are respectively received in a pivot detent or pivot socket (not shown) which can be journalled for rotation and formed in parts of the vehicle instrument or dash panel in which the glovebox 40 is rotatively received producing a flip open glovebox 40 that can be flipped down open and flipped up closed. During opening and closing of the glovebox 40, the glovebox pivots about the pivot pins 58, 60 respectively received in the pivot detent or pivot socket formed in an interior part of the vehicle dash or instrument panel.

In another preferred embodiment, the glovebox 40 can be formed with pivot pin 58 extending outwardly from one sidewall 52 and a pivot-pin receiving bore 64 formed in the other sidewall 54 that is generally coaxial with pivot pin 58. During assembly, a portion of the dash or instrument panel in which the glovebox 40 is received has a male pivot pin that extends into and through the bore 64 with pivot pin 58 received in a pivot-pin receiving bore formed in the portion of the dash or instrument panel receiving the glovebox 40.

Although not shown, the glovebox 40 is part of a glovebox assembly that includes a cover or lid configured with a latch that releasably engages with part of a glovebox latching assembly formed in or carried by part of the vehicle dash or instrument panel that releasably retains the glove box 40 in the flipped up closed position. In a preferred embodiment, the latching assembly can also include a lock, such as a solenoid and/or key locking mechanism which releasably, positively and securely locks the glovebox 40 in the closed flipped up position to prevent access to articles held within the recessed compartment within the glovebox 40.

In a preferred glovebox and implementation of a method of making such a glovebox, the blank 42 from which the three dimensionally shaped glovebox substrate 44 is molded that forms the glovebox 40 is composed of a webbing or at least one layer of a fibrous material 66 that preferably is a thermoplastic fibrous material 68 that more preferably is a nonwoven fibrous material 70 composed of thermoplastic fibers, such as polyethylene terephthalate (PET) fibers, polypropylene (PP) fibers, nylon fibers, polybutylene terephthalate (PBT) fibers, polybenzimidazole (PBI) fibers, or a combination of at least a plurality and preferably at least a plurality of pairs, i.e., at least three, of types of these thermoplastic fibers. Use of such a moldable blank 42 composed of at least 30%, preferably at least 45% and more preferably greater than 55% thermoplastic fibers by weight of the blank 42 produces a three-dimensionally shaped molded glovebox substrate 44 that has good ductility, excellent toughness, good compliancy, high resiliency, is not excited by noise and/or vibration into resonance nor into acoustic amplification of sound and/or vibration, is of sound and noise dampening construction, and which is of vibration isolating construction producing a glovebox 40 of the present invention that not only does not transmit noise or vibration but which dampens and suppresses noise and vibration.

In one such preferred embodiment, the at least one layer of non-woven heat formable fibrous material 70 further includes at least one of the following types of non-thermoplastic fibers: glass fibers, carbon fibers, aramid fibers, a natural fiber or fibers, or a combination of a plurality of such non-thermoplastic fibers. Such a moldable blank 42 is composed of at least 25%, preferably at least 35% and more preferably greater than 45% thermoplastic fibers by weight of the blank 42 produces a three-dimensionally shaped molded glovebox substrate 44 that has good ductility, excellent toughness, good compliancy, high resiliency, is not excited by noise and/or vibration into resonance nor into acoustic amplification of sound and/or vibration, is of sound and noise dampening construction, and which is of vibration isolating construction producing a glovebox 40 of the present invention that not only does not transmit noise or vibration but which dampens and suppresses noise and vibration.

In another preferred glovebox and implementation of a method of making such a glovebox, the blank 42 from which the three dimensionally shaped glovebox substrate 44 is molded that forms the glovebox 40 is composed of at least one woven layer of a fibrous material 66 that preferably is a thermoplastic fibrous material 68 that more preferably is a high density woven fibrous material composed of thermoplastic fibers, such as polyethylene terephthalate (PET) fibers, polypropylene (PP) fibers, nylon fibers, polybutylene terephthalate (PBT) fibers, polybenzimidazole (PBI) fibers, or a combination of at least a plurality and preferably at least a plurality of pairs, i.e., at least three, of types of these thermoplastic fibers. Use of such a moldable blank 42 composed of at least 30%, preferably at least 45% and more preferably greater than 55% thermoplastic fibers by weight of the blank 42 produces a three-dimensionally shaped molded glovebox substrate 44 that has good ductility, excellent toughness, good compliancy, high resiliency, is not excited by noise and/or vibration into resonance nor into acoustic amplification of sound and/or vibration, is of sound and noise dampening construction, and which is of vibration isolating construction producing a glovebox 40 of the present invention that not only does not transmit noise or vibration but which dampens and suppresses noise and vibration.

In one such preferred embodiment, the at least one layer of woven heat formable fibrous material further includes at least one of the following types of non-thermoplastic fibers: glass fibers, carbon fibers, aramid fibers, a natural fiber or fibers, or a combination of a plurality of such non-thermoplastic fibers. Use of such a moldable blank 42 composed of at least 30%, preferably at least 45% and more preferably greater than 55% thermoplastic fibers by weight of the blank 42 produces a three-dimensionally shaped molded glovebox substrate 44 that has good ductility, excellent toughness, good compliancy, high resiliency, is not excited by noise and/or vibration into resonance nor into acoustic amplification of sound and/or vibration, is of sound and noise dampening construction, and which is of vibration isolating construction producing a glovebox 40 of the present invention that not only does not transmit noise or vibration but which dampens and suppresses noise and vibration.

With continued reference to FIGS. 1-5, the molded substrate 44 forms an exterior or outer layer of the glovebox 40 and the glovebox 40 includes a decorative, softer, smoother and/or more compliant article protecting and/or article rattle preventing inner layer 72 that preferably is a layer of soft noise absorbing carpet 74 that more preferably is a layer of thermally formable thermoplastic fibrous carpet material 76. To best dampen or deaden noise and sound as well as to prevent squeaks, rattles and buzzing, substantially the entire inner surface of the compartment 46 is covered with or in such an interior layer 72 of soft-touch carpet 74 that preferably is an inner layer of thermally formable thermoplastic fibrous carpet material 76 attached, e.g., fixed, to the molded substrate 44.

In a preferred glovebox embodiment, such a soft resilient sound and vibration absorbing and dampening inner layer 72 is fixed to an outer moldable substrate layer 65 by needle tacking the inner layer 72 thereto and heating the layers 65 and 72 via convection or conductive, e.g., hot platen, heating to produce a multilayer thermally formable blank 74. The multilayer thermally formable blank 74 is compression molded using chilled compression molding tools that can include chilled compression molds to chill mold the multilayer blank 74 into a three-dimensionally shaped glovebox 40 like the glovebox 40 shown in FIGS. 1-5. Once formed into the desired three-dimensional recessed glovebox shape like that depicted in FIGS. 1-5, any excess blank material is trimmed via a 3D trimming process and/or a water jet cutting process to produce a multilayer three-dimensionally formed glovebox 40 of flip-open construction, e.g., flip up and flip down construction, in accordance with the present invention.

In a preferred embodiment, such a multilayer three-dimensionally formed glovebox 40 has a specific weight of no greater than 2800 g/m2 that preferably has a specific weight between 500 g/m2 to 2500 g/m2 thereby advantageously producing a lighter weight glovebox 40 that also is of sound deadening and vibration dampening construction. The glovebox 40 preferably is friction welded, ultrasonic welded or heat staked to a door assembly or lid assembly (not shown) of the glovebox assembly. Such a glovebox 40 constructed of a multilayer moldable blank 74 formed of softer sound-absorbing inner layer 72 and structural sound dampening and/or vibration isolating moldable substrate layer 65 produces a glovebox 40 of the present invention that provides two-stage sound reduction and which advantageously is at least 30% lighter, preferably about 40% lighter, while eliminating the need for more expensive flocking material used on conventional hard plastic injection molded gloveboxes. Such a multi-layer multi-stage sound absorbing and vibration dampening glovebox 40 of the present invention is formed of a single molded piece of the multilayer moldable blank 74 produces a one-piece glovebox 40 or inner glovebox bin 41 of flip open construction used in over a majority of automotive vehicles presently produced today.

TABLE A
Sound Absorption Comparison of Injection Molded Hard Plastic
Glovebox vs Thermoplastic Fiber Molded Glovebox

| Freq. | 400 | 500 | 630 | 800 | 1000 | 1250 | 1600 | 2000 | 2500 | 3150 | 4000 | 5000 | 6300 | 8000 | 10000 |
|---|---|---|---|---|---|---|---|---|---|---|---|---|---|---|---|
| PET | 0.132 | 0.193 | 0.208 | 0.370 | 0.562 | 0.645 | 0.747 | 0.822 | 0.932 | 0.865 | 0.937 | 0.904 | 0.943 | 0.870 | 0.893 |
| Plastic | 0.142 | 0.184 | 0.177 | 0.277 | 0.335 | 0.387 | 0.480 | 0.512 | 0.516 | 0.502 | 0.517 | 0.526 | 0.480 | 0.492 | 0.454 |
| None | 0.135 | 0.176 | 0.172 | 0.263 | 0.326 | 0.360 | 0.458 | 0.503 | 0.509 | 0.505 | 0.519 | 0.525 | 0.486 | 0.474 | 0.460 |

Table A above depicts the significantly improved sound absorption characteristics of a glovebox 40 made of a molded substrate 44 of thermoplastic fiber construction as compared to a conventional injection-molded hard plastic glovebox. The first row of data shows a 1/3 octave band center frequency in Hertz, while the remaining rows show an absorption coefficient for the given frequency. Table A makes clear that significantly sound is absorbed by a glovebox 40 composed of a three-dimensionally formed molded glovebox substrate 44 composed of molded PET fiber (second row of data), preferably composed of at least 40% PET fiber and more preferably composed of at least 55% PET fiber by weight of the substrate 44, as compared to a conventional plastic injection molded glovebox molded of a hard plastic like polypropylene (third row of data). A fourth row of data also shows no glovebox being used.

In a preferred embodiment, the moldable substrate layer 65 is constructed of an engineered blend of PET fibers composed of 2-19 denier matrix fiber, preferably 4-17 denier matrix fiber, and more preferably 6-15 denier matrix fiber, and a high temperature crystalline or amorphous fiber binder that imparts excellent dimensional stability and good rigidity to the moldable substrate layer 65 after being three dimensional molded into a desired glovebox shape. When chill molded in the manner disclosed above, the resultant three-dimensionally contoured or shaped moldable substrate layer 65 is rigid enough to provide structural support to the glovebox 40 while providing excellent dimensional stability to meet tight enough tolerances for assembly into the dash or instrument panel of a vehicle that also provides sound and vibration dampening and/or absorption. When PET fiber moldable substrate 65 is combined with a soft-touch inner carpet face layer 72 also composed of PET fiber to form such a multilayer thermally formable or moldable blank 74, the resultant glovebox 40 formed therefrom by chill molding advantageously provides at least two stage sound reduction. To combine such a PET fiber inner carpet face 72 with such a moldable PET fiber substrate 65, the carpet face layer 72 preferably is needle tacked to the moldable PET fiber substrate 65 to form thermally formable or moldable blank 74 that is composed of at least these two layers 65 and 72.

Where an inner carpet face layer 72 is employed, the inner carpet face layer 72 preferably is composed of at least 50% PET by weight of the layer 72 and can be of flat faced needled, e.g., needle-punched, or dilour construction. In one preferred embodiment, the inner carpet face layer 72 is of flat faced needled construction composed of at least 70% PET fiber, preferably composed substantially completely, e.g., at least 95%, PET fiber, by weight of layer 72. In another preferred embodiment, the inner carpet face layer 72 is of dilour or plush pile non-woven construction composed of at least 70% PET fiber, preferably composed substantially completely, e.g., at least 95%, PET fiber, by weight of layer 72.

In a preferred embodiment of a multilayer multistage sound reducing glovebox 40 of the present invention, the softer cushioning inner PET carpet face layer 72 prevents articles within the glove compartment from rattling, producing buzzing, or causing squeaking thereby suppressing and preferably substantially completely preventing sound generation within the glovebox compartment. Use of softer cushioning inner PET carpet face layer 72 preferably also causes sound reduction by absorbing sound and vibration within the glovebox compartment. The outer structurally supporting PET fiber moldable substrate layer 65 not only serves as a generally rigid frame of the glovebox 40 but also advantageously is of vibration isolating construction thereby isolating vibration and preventing sound transmission through the glovebox 40.

In forming such a glovebox 40 made of a thermally moldable blank 74 composed of at least a plurality of layers 65 and 72, namely a PET fiber carpet face layer 72 needle tacked to a structurally supporting PET fiber moldable substrate 65, the resultant glovebox 40 produced after three dimensionally chill molding of the blank 74 is of one-piece flip open two stage sound and noise reducing construction. Such a noise absorbing and vibration dampening glovebox 40 preferably is formed or molded with oppositely outwardly extending pivot pins 58, 60 that enable the flip open glovebox 40 to simply and easily rotate within a vehicle dash or instrument panel about a common central rotational axis extending through a longitudinal centerline of the pivot pins 58, 60 between open and closed positions during glovebox use and operation. Such a glovebox 40 of noise absorbing and vibration isolating construction advantageously is easily attached to a glovebox door or lid assembly via friction welding, ultrasonic welding, or heat staking.

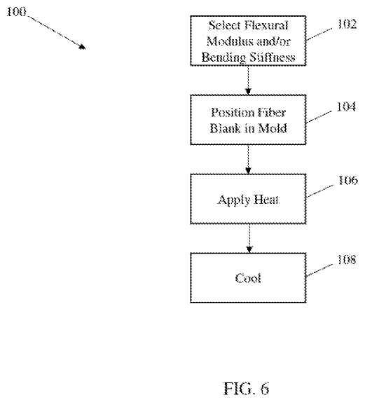

FIG. 6 is flowchart describing a method or process 100 suitable for manufacturing the vibration isolating glovebox 40. The process 100 may be implemented as computer code, for example executable by an industrial control system, to manufacture the vibration isolating glovebox in In the depicted embodiment, the process 100 may first select (block 102), a flexural modulus and/or a bending stiffness for the vibration isolating glovebox 40. The flexural modulus may be an intensive property computed as a ratio of stress to strain in flexural deformation. The bending stiffness may be a resistance of a member against bending deformation. Selection (block 102) of the flexural modulus and/or the bending stiffness may result in selecting a glovebox blank 42 made of a certain mesh, such as a porous fibrous material (e.g., PET fibers, PBT fibers, PBI fibers, other synthetic fibers, or a combination thereof), that may provide the desired flexural modulus and/or bending stiffness. For example, the mesh may include a certain fibers by weight for the glovebox blank 42 that may then provide the desired flexural modulus and/or bending stiffness, e.g., based on the geometric shape for the vibration isolating glovebox 40.

The process 100 may then position (block 104) the glovebox blank 42, for example, in a three-dimensionally shaped mold having a desired glovebox geometry. The glovebox blank 42 may then be heated (block 106) to thermally form the glovebox blank 42 to produce a one-piece glovebox compartment. In certain embodiments, convective or conductive thermal forming or molding may be applied to thermally create the desired shape in the mold. As mentioned earlier, the resulting shape may be one-piece, and may include fastening components such as pins 58, 60, used to fasten the vibration isolating glovebox 40 inside a vehicle compartment. The process 100 may then cool (block 108) the now formed vibration isolating glovebox 40. For example, cooling may be done by waiting a certain time after removing heat, or by applying cooling, e.g., chill molding as mentioned above. The vibration isolating glovebox 40 may then be provided, for example, to an assembly line, to be installed in a vehicle. By manufacturing the vibration isolating glovebox 40 via the process 100, a flip-open type construction may be thermally formed as a three-dimensionally shaped structurally supporting glovebox article-holding compartment.

Understandably, the present invention has been described above in terms of one or more preferred embodiments and methods. It is recognized that various alternatives and modifications can be made to these embodiments and methods that are within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention. The present invention, therefore, is intended to be limited only by the scope of the appended claims.

1. A glovebox assembly comprised of a thermally moldable blank formed into a three-dimensional glovebox bin.

2. The glovebox assembly of claim 1, wherein the moldable blank is comprised of a fibrous material molded into three-dimensional glovebox shape having a recessed article-holding glovebox compartment formed therein.

3. The glovebox assembly of claim 2, wherein the moldable blank is comprised of at least one layer of thermoplastic fibrous material comprised of a plurality of pairs of thermoplastic fibers substantially uniformly distributed throughout.

4. The glovebox assembly of claim 3, wherein the moldable blank is comprised of at least one glovebox structure providing layer composed of polyethylene terephthalate (PET) fiber that is three dimensionally chill formed into the glovebox bin.

5. The glovebox assembly of claim 4, wherein the glovebox bin is of one-piece flip open construction comprised of a pair of generally coaxial pivot pins about which the glovebox bin rotates between an open position, providing access to a recessed article-holding compartment of the glovebox bin, and a closed position, preventing access to the recessed article-holding compartment of the glovebox bin.

6. The glovebox assembly of claim 4, wherein the moldable blank is further comprised of an inner carpet layer mated to the at least one glovebox structure providing layer providing a carpeted inner glovebox compartment surface.

7. The glovebox assembly of claim 6, wherein the moldable blank is further comprised of an inner carpet layer mated to the at least one glovebox structure providing layer providing a carpeted inner glovebox compartment surface that absorbs sound and prevents generation of noise from articles within the glovebox bin compartment.

8. The glovebox assembly of claim 7, wherein the at least one glovebox structure is comprised of PET fiber in a fiber matrix comprised of an amorphous or crystalline binder.

9. The glovebox assembly of claim 8, wherein the at least one glovebox structure is comprised of a PET fiber matrix of between 6-15 denier.

10. The glovebox assembly of claim 9, wherein the inner carpet layer is comprised of PET fiber and has one of a flat needled face and a dilour surface.

11. A method for manufacturing glovebox, comprising:
positioning a moldable blank onto a mold having a three-dimensional glovebox shape;
applying heat to the moldable blank, applying cooling to the moldable blank, or a combination thereof, to shape the moldable blank into a molded three-dimensional glovebox bin;
wherein the moldable blank comprises at least one layer of synthetic fibrous material.

12. The method of claim 11, wherein the synthetic fibrous material comprises at least one layer of thermoplastic fibrous material comprised of a plurality of pairs of thermoplastic fibers substantially uniformly distributed throughout.

13. The method of claim 12, wherein the moldable blank comprises at least one glovebox structure providing layer composed of polyethylene terephthalate (PET) fiber that is three dimensionally chill formed into the glovebox bin, wherein the glovebox bin is of one-piece flip open construction comprised of a pair of generally coaxial pivot pins about which the glovebox bin rotates between an open position, providing access to a recessed article-holding compartment of the glovebox bin, and a closed position, preventing access to the recessed article-holding compartment of the glovebox bin.

14. The method of claim 11, comprising selecting a flexural modulus, a bending stiffness, or a combination thereof, before positioning the moldable blank, and wherein applying the heat, applying the cooling, or combination thereof, results in the molded three-dimensional glovebox bin having the flexural modulus, bending stiffness, or combination thereof.

15. The method of claim 12, wherein the moldable blank comprises only synthetic fibrous materials.

16. A glovebox system, comprising:
a moldable blank formed into a three-dimensional glovebox bin, wherein the moldable blank comprises at least one layer of synthetic fibrous material, and wherein after forming the moldable blank into the three-dimensional glovebox bin, the three-dimensional glovebox bin comprises a larger sound absorption coefficient at a frequency range when compared to a hard plastic glovebox bin.

17. The glovebox system of claim 16, wherein the three-dimensional glovebox bin comprises a weight smaller than the hard plastic glovebox bin, and wherein the frequency range comprises a 1/3 octave band center frequency range greater than or equal to 500 Hertz.

18. The glovebox system of claim 16, wherein the moldable blank comprises at least one glovebox structure providing layer composed of polyethylene terephthalate (PET) fiber, wherein the glovebox bin is of one-piece flip open construction comprised of a pair of generally coaxial pivot pins about which the glovebox bin rotates between an open position, providing access to a recessed article-holding compartment of the glovebox bin, and a closed position, preventing access to the recessed article-holding compartment of the glovebox bin.

19. The glovebox system of claim 18, wherein the at least one glovebox structure is comprised of a PET fiber matrix of between 6-15 denier.

20. The glovebox system of claim 16, wherein the three-dimensional glovebox bin comprises only synthetic fibrous materials.
